(19) United States
(12) Patent Application Publication
(10) Pub. No.: US 2014/0190369 A1
(43) Pub. Date: Jul. 10, 2014

(54) POLYURETHANE POLYMERS

(71) Applicants: Evelyn Peiffer, Leverkusen (DE); Mathias Matner, Neuss (DE)

(72) Inventors: Evelyn Peiffer, Leverkusen (DE); Mathias Matner, Neuss (DE)

(73) Assignee: Bayer Intellectual Property GmbH, Monheim (DE)

(21) Appl. No.: 14/124,487

(22) PCT Filed: Jun. 5, 2012
(86) PCT No.: PCT/EP2012/060590

§ 371 Date: Mar. 17, 2014

(30) Foreign Application Priority Data
Jun. 8, 2011 (DE) 10 2011 077 201.4

(51) Int. Cl. C09J 175/04

(52) U.S. Cl. CPC C09J 175/04
USPC 106/287.11; 556/420; 524/869

(57) ABSTRACT

The present invention relates to polyurethane polymers, a process for their preparation and their use as binders for adhesives, coatings or foams.

The present invention relates to non-aqueous polyurethane polymers, a process for their preparation and their use as binders for adhesives, coatings or foams.

Alkoxysilane-functional polyurethanes which crosslink via a silane polycondensation have been known for a long time. An overview article on this subject is to be found e.g. in “Adhesives Age” 4/1995, page 30 et seq. (authors: Ta-Min Feng, B. A. Waldmann). Such alkoxysilane-terminated moisture-curing one-component polyurethanes are increasingly being used as flexible coating, sealing and adhesive compositions in the building industry and in the automobile industry.

According to U.S. Pat. No. 3,627,722 or DE-A 1 745 526, such alkoxysilane-functional polyurethanes can be prepared by e.g. reacting polyether polyols with an excess of polyisocyanate to give an NCO-containing prepolymer, which is then in turn reacted further with an amino-functional alkoxysilane.

The publications EP-A 0 397 036, DE-A 19 908 562 (corresponds to EP-A 1 093 482) and US-A 2002/0100550 describe further different routes for the preparation of alkoxysilane-terminated polymers. According to these publications, in each case high molecular weight polyethers having an average molecular weight of 4,000 g/mol or higher are employed.

The application EP-A 0 070 475 describes the preparation and use of alkoxysilane-terminated polymers starting from hydrogen-acid prepolymers by termination with NCO-functional alkoxysilanes. Polyols having a molecular weight of 500-6,000 g/mol are used for the prepolymer synthesis. The polymers described therein are employed as binders in sealant formulations, that is to say flexible systems.

An analogous process is described in the application DE-A 10 2007 058 344.

The possibility of arriving at prepolymers of particularly low viscosity by using isocyanate-functional alkoxysilane units is disclosed inter alia in U.S. Pat. No. 4,345,053. In this, an OH-functional prepolymer is terminated by an isocyanate-functional alkoxysilane, which in the end means the saving of one urea group per termination. Nevertheless, the OH-functional prepolymer still comprises urethane groups which result from the prelengthening of a polyether polyol with diisocyanate. As is likewise disclosed in EP-A 372 561, these can be saved by employing specially prepared long-chain polyethers having a low degree of unsaturation and polydispersity. Nevertheless, in the stoichiometric reaction of such isocyanate-functional alkoxysilane units binders are obtained which, because of inadequate masking, above all if very long-chain polyethers are used, cannot crosslink adequately during curing. This leads to very soft polymers having a high surface tackiness and a lack of resilience, or a high plastic deformability.

EP-A 1 924 621 (corresponds to WO2007025668) describes the preparation and use of alkoxysilane-terminated polymers starting from polyether polyols by termination with NCO-functional alkoxysilanes. Polyols having a molecular weight of 3,000-20,000 g/mol are used for the synthesis. The polymers described therein are employed as binders in sealant formulations, that is to say flexible systems.

All of these alkoxysilane-terminated systems form, after curing, flexible polymers having a relatively low strength and a high elongation at break. DE-A 1 745 526 describes tensile strengths in the range of from 3.36 kg/cm² to 283 kg/cm² for polyoxypropylene glycol-based polymers. Only with crystallizing polycaprolactones are higher strengths which are adequate for structural gluings achieved.

However, these systems have the disadvantage that they are very highly viscous or even solid at room temperature and therefore can only be processed hot.

The field of use of the abovementioned applications is accordingly limited on the one hand to sealants and flexible adhesives and on the other hand to highly viscous or solid systems, which can only be processed hot.

The present invention was therefore based on the object of providing alkoxysilane-terminated polyurethanes which are liquid at room temperature and achieve a high cohesive strength when cured, so that adhesives which render possible structural gluing can be formulated using them.

It has now been found that such alkoxysilane-terminated polyurethanes having the required properties can be prepared by reacting compounds having isocyanate-reactive groups and a hydroxyl number—or correspondingly an amine or thiol number—of greater than 30 mg of KOH/g with an isocyanate-functional alkoxysilane.

The invention therefore provides polymers modified with alkoxysilane groups, which are obtainable by reaction
a) of compounds or mixtures of compounds having isocyanate-reactive groups and a hydroxyl number or amine or thiol number of greater than 30 mg of KOH/g
with
b) an isocyanate-functional alkoxysilane compound of the general formula (I):

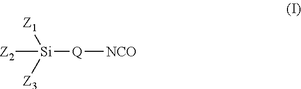

wherein
Z¹, Z² and Z³ are identical or different C₁-C₈-alkoxy or C₁-C₈-alkyl radicals, which can also be bridged, but wherein at least one C₁-C₈-alkoxy radical must be present on each Si atom,
Q is an at least difunctional linear or branched organic radical, preferably an alkylene radical having 1 to 8 carbon atoms.

In this context, the reaction of b) with a) can preferably be carried out in a ratio of from 0.8:1.0 to 1.5:1.0 (NCO:isocyanate-reactive hydrogen).

The compounds according to the invention are non-crystallizing substances which are liquid at room temperature. They have a viscosity at 23° C. of less than 20 Pas, preferably less than 10 Pas, particularly preferably less than 5 Pas. In this context the viscosity is determined in accordance with the method described in the experimental part.

The compounds according to the invention preferably have a number-average molecular weight of less than 4,500 g/mol, particularly preferably of less than 4,000 g/mol and very particularly preferably of less than 3,000 g/mol. In this context the number-average molecular weight is determined in accordance with the method described in the experimental part.

All the compounds known to the person skilled in the art which have isocyanate-reactive groups and a functionality of on average at least two can be employed in part a). These can be, for example, low molecular weight, multifunctional, isocyanate-reactive compounds, such as aliphatic polyols, polyamines or polythiols, aromatic polyols, polyamines or polythiols, or can be higher molecular weight isocyanate-reactive compounds, such as polyether polyols, polyether amines, polycarbonate polyols, polyester polyols and polythioether polyols. Preferably, such isocyanate-reactive compounds have an average functionality of from 2 to 6, preferably 2 to 4 and particularly preferably from 2 to 3.

Preferably, these are polyether polyols or polyether polyamines, particularly preferably polyether polyols. These are accessible in a manner known per se by alkoxylation of suitable starter molecules under base catalysis or with the use of double metal cyanide compounds (DMC compounds). Suitable starter molecules for the preparation of polyether polyols are molecules having at least two element-hydrogen bonds which are reactive towards epoxides or any desired mixtures of such starter molecules.

Particularly suitable polyether polyols are those of the abovementioned type having a content of unsaturated end groups of less than or equal to 0.02 milliequivalent per gram of polyol (meq/g), preferably less than or equal to 0.015 meq/g, particularly preferably less than or equal to 0.01 meq/g (determination method ASTM D2849-69).

This is described e.g. in U.S. Pat. No. 5,158,922 (e.g. Example 30) and EP-A 0 654 302 (p. 5, 1. 26 to p. 6, 1. 32).

Suitable starter molecules for the preparation of polyether polyols are, for example, water or simple, low molecular weight alcohols, such as, for example, methanol, ethanol, ethylene glycol, propane-1,2-diol, 2,2-bis(2-hydroxyphenyl)propane, propylene 1,3-glycol and butane-1,4-diol, hexane-1,6-diol, neopentyl glycol, 2-ethylhexane-1,3-diol, trimethylolpropane, glycerol, pentaerythritol, sorbitol, organic polyamines having at least two N—H bonds, such as e.g. triethanolamine, ammonia, methylamine or ethylenediamine, or any desired mixtures of such starter molecules. Alkylene oxides which are suitable for the alkoxylation are, in particular, ethylene oxide and/or propylene oxide, which can be employed in the alkoxylation in any desired sequence or also in a mixture.

Polyether polyol mixtures which comprise a polyol having at least one tertiary amino group can also be employed. Such polyether polyols having tertiary amino groups can be prepared by alkoxylation of starter molecules or mixtures of starter molecules at least comprising a starter molecule having at least 2 element-hydrogen bonds which are reactive towards epoxides, at least one of which is an NH bond, or low molecular weight polyol compounds which carry tertiary amino groups. Example of suitable starter molecules are ammonia, methylamine, ethylamine, n-propylamine, iso-propylamine, ethanolamine, diethanolamine, triethanolamine, ethylenediamine, ethylenetriamine, triethanolamine, N-methyldiethanolamine, ethylenediamine, N,N′-dimethyl-ethylenediamine, tetramethylenediamine, hexamethylenediamine, 2,4-toluylenediamine, 2,6-toluylenediamine, aniline, diphenylmethane-2,2′-diamine, diphenylmethane-2,4′-diamine, diphenylmethane-4,4′-diamine, 1-aminomethyl-3-amino-1,5,5-trimethylcyclohexane (isophoronediamine), dicyclohexylmethane-4,4′-diamine, xylylenediamine and polyoxyalkylene-amines.

The polytetramethylene ether glycols obtainable by polymerization of tetrahydrofuran, and also polybutadienes comprising hydroxyl groups can also be employed.

Hydroxyl-polycarbonates are to be understood as meaning reaction products of glycols of the ethylene glycol, diethylene glycol, 1,2-propylene glycol, 1,4-butanediol, neopentyl glycol or 1,6-hexanediol type and/or triols, such as, for example, glycerol, trimethylolpropane, pentaerythritol or sorbitol, with diphenyl carbonate and/or dimethyl carbonate. The reaction is a condensation reaction, in which phenol and/or methanol are split off.

Polyether carbonate polyols such as are obtainable, for example, by catalytic reaction of alkylene oxides (epoxides) and carbon dioxide in the presence of H-functional starter substances (see e.g. EP-A 2 046 861) can also be employed.

The hydroxyl-polyesters are to be understood as meaning reaction products of aliphatic, cycloaliphatic, aromatic and/or heterocyclic polybasic, but preferably dibasic carboxylic acids, such as, for example, adipic acid, azelaic acid, sebacic acid and/or dodecandioic acid, phthalic acid, isophthalic acid, succinic acid, suberic acid, trimellitic acid, phthalic anhydride, tetrahydrophthalic anhydride, glutaric anhydride, tetrachlorophthalic anhydride, endomethylenetetrahydrophthalic anhydride, maleic anhydride, maleic acid, fumaric acid, dimeric and trimeric fatty acids, such as oleic acid, optionally in a mixture with monomeric fatty acids, terephthalic acid dimethyl ester or terephthalic acid bis-glycol ester, ortho-, iso- or terephthalic acid with polyfunctional, preferably difunctional or trifunctional alcohols, such as, for example, ethylene glycol, diethylene glycol, triethylene glycol, tetraethylene glycol, 1,2-/1,3-propanediol and 1,4-/1,3-butanediol, 1,6-hexanediol, 1,8-octanediol, neopentyl glycol, 1,4-bis(hydroxymethyl)cyclohexane, bis(hydroxymethyl)tricyclo[5.2.1.0^{2.6}]decane or 1,4-bis(2-hydroxyethoxy)benzene, 2-methyl-1,3-propanediol, 2,2,4-trimethylpentanediol, 2-ethyl-1,3-hexanediol, dipropylene glycol, polypropylene glycols, dibutylene glycol, polybutylene glycols, 1,4-phenoldimethanol, bisphenol A, tetrabromobisphenol A, glycerol, trimethylolpropane, 1,2,6-hexanetriol, 1,2,4-butanetriol, pentaerythritol, quinitol, mannitol, sorbitol, methyl glycoside or 1,4:3,6-dianhydrohexitols. Instead of the free polycarboxylic acids, the corresponding polycarboxylic acid anhydrides or corresponding polycarboxylic acid esters of lower alcohols or mixtures thereof can also be co-used for preparation of the polyester.

There are to be mentioned here also, in particular, the products which are derived from reaction products of glycerol and hydroxyl-fatty acids, in particular castor oil and its derivatives, such as, for example, monodehydrated castor oil.

Corresponding poly-ε-caprolactones terminated by hydroxyl groups can also be employed.

Polyamines, for example polyether amines, or also polythiols can be employed in addition to or instead of the polyhydroxy compounds in part a). With respect to the preferred amine or thiol numbers, the same limits apply as already listed for the hydroxyl numbers of the polyhydroxy compounds.

In principle all monoisocyanates comprising alkoxysilane groups and having a molecular weight of from 140 g/mol to 500 g/mol are suitable as isocyanate-functional alkoxysilane compounds of the general formula (I) (part b)). Examples of such compounds are isocyanatomethyltrimethoxysilane, isocyanatomethyltriethoxysilane, (isocyanatomethyl)methyldimethoxysilane, (isocyanato-methyl)methyldiethoxysilane, 3-isocyanatopropyltrimethoxysilane, 3-isocyanatopropylmethyl-dimethoxysilane, 3-isocyanatopropyltriethoxysilane and 3-isocyanatopropylmethyldiethoxysilane. The use of 3-isocyanatopropyltrimethoxysilane is preferred here.

According to the invention it is also possible to use isocyanate-functional silanes which have been prepared by reaction of a diisocyanate with an amino- or thiosilane, such as are described in U.S. Pat. No. 4,146,585 or EP-A 1 136 495.

The reaction of b) with a) is preferably carried out in a ratio of from 0.8:1.0 to 1.5:1.0 (NCO isocyanate-reactive hydrogen), particularly preferably in a ratio of from 1.0:1.0 to 1.5:1.0, very particularly preferably in a ratio of from 1.0:1.0 to 1.2:1,0. Preferably, the isocyanate is employed in an equimolar amount or in excess, at any rate such that the resulting polymers according to the invention are completely alkoxysilane-terminated. If necessary, the optimum ratio for a specific substance combination of b) and a) is to be determined by orientating preliminary experiments, which is a conventional procedure for the person skilled in the art.

If an excess of part b) is employed, the urethanization of parts a) and b) is carried out to complete conversion of the NCO groups.

If a deficient amount of part a) is employed, the urethanization of parts a) and b) is continued until a complete conversion of the isocyanate-reactive groups is achieved. In order to ensure complete conversion of all the isocyanate-reactive groups, it is preferable for the reaction conditions to be maintained, even after the theoretical NCO content is reached, until a constant NCO content is observed.

Two routes are possible for the further degradation of the NCO content of the reaction product of parts a) and b), as described in EP-A 1 924 621. The first possibility comprises the addition of a further NCO-reactive component, which is reacted with the remaining NCO groups in a subsequent reaction step. These can be, for example, low molecular weight alcohols.

The second possibility for the further degradation of the NCO content of the reaction product of parts a) and b) is an allophanation reaction. In this context the remaining NCO groups are reacted with the urethane groups formed beforehand, preferably by addition of a catalyst which promotes allophanation.

The course of the urethanization reaction can be monitored by suitable measuring equipment installed in the reaction vessel and/or with the aid of analyses of samples taken. Suitable methods are known to the person skilled in the art. They are, for example, viscosity measurements, measurements of the NCO content, the refractive index or the OH content, gas chromatography (GC), nuclear magnetic resonance spectroscopy (NMR), infra-red spectroscopy (IR) and near infra-red spectroscopy (NIR). Preferably, the NCO content of the mixture is determined titrimetrically.

The reaction of part a) with part b) is preferably carried out in a temperature range of from 20° C. to 200° C., particularly preferably within from 40° C. to 120° C. and particularly preferably from 60° C. to 100° C.

It is irrelevant whether the process is carried out continuously, e.g. in a static mixer, extruder or kneader, or discontinuously, e.g. in a stirred reactor.

The process is preferably carried out in a stirred reactor.

The invention also provides adhesives, coatings or foams based on the polyethers according to the invention. These adhesives, coatings or foams crosslink under the action of moisture from the atmosphere via a silanol polycondensation. Preferably, the polymers according to the invention are employed in coatings and adhesives, particularly preferably in adhesives which, according to the measurement method described in the experimental part, have a tensile shear strength of at least 5 N/mm².

For the preparation of such adhesives, coatings and foams, the polymers according to the invention comprising alkoxysilane end groups can be formulated by known processes together with conventional solvents or blowing agents, plasticizers, flameproofing agents, fillers, pigments, desiccants, additives, light stabilizers, antioxidants, thixotropy agents, catalysts, adhesion promoters and optionally further auxiliary substances and additives.

Typical foams and adhesive and coating preparations according to the invention comprise, for example, 5 wt. % to 100 wt. % of a polymer modified with alkoxysilane groups, according to claim 1, or of a mixture of two or more such polymers modified with alkoxysilane groups, up to 50 wt. % of a plasticizer/flameproofing agent or of a mixture of two or more plasticizers, up to 95 wt. % of a solvent/blowing agent or of a mixture of two or more solvents/blowing agents, up to 20 wt. % of a moisture stabilizer or of a mixture of two or more moisture stabilizers, up to 5 wt. % of an antiageing agent or of a mixture of two or more antiageing agents, up o 5 wt. % of a catalyst or of a mixture of two or more catalysts and up to 80 wt. % of a filler or of a mixture of two or more fillers.

In the simplest case, air or nitrogen can be employed as a blowing agent, but all other blowing agents known per se from polyurethane chemistry can of course also be employed for foaming the composition according to the invention. Examples which may be mentioned are n-butane, i-butane, propane and dimethyl ether, as well as mixtures of the abovementioned agents.

Suitable fillers which may be mentioned by way of example are carbon blacks, precipitated silicas, pyrogenically produced silicas, mineral chalks and precipitated chalks or also fibrous fillers. Suitable plasticizers which may be mentioned by way of example are phthalic acid esters, adipic acid esters, alkylsulfonic acid esters of phenol, phosphoric acid esters or also higher molecular weight polypropylene glycols.

Flameproofing agents which can be employed are the typical halogen- or phosphorus-containing compounds, and likewise inorganic flameproofing agents, such as, for example, aluminium oxide hydrate.

Thixotropy agents which may be mentioned by way of example are pyrogenically produced silicas, polyamides, hydrogenated castor oil secondary products or also polyvinyl chloride.

Suitable catalysts which can be employed for curing of the adhesives, coatings or foams according to the invention are all the organometallic compounds and aminic catalysts which are known to promote silane polycondensation. Particularly suitable organometallic compounds are, in particular, compounds of tin and of titanium. Preferred tin compounds are, for example: dibutyltin diacetate, dibutyltin dilaurate, dioctyltin maleate and tin carboxylates, such as, for example, tin(II) octoate or dibutyltin bis-acetoacetonate. The tin catalysts mentioned can optionally be used in combination with aminic catalysts, such as aminosilanes or 1,4-diazabicyclo[2.2.2]octane. Preferred titanium compounds are, for example, alkyl titanates, such as diisobutyl-bisacetoacetic acid ethyl ester titanate. Aminic catalysts which are suitable for sole use are, in particular, those which have a particularly high base strength, such as amines having an amidine structure. Preferred aminic catalysts are therefore, for example, 1,8-diazabicyclo[5.4.0]undec-7-ene or 1,5-diazabicyclo[4.3.0]-non-5-ene. Brønstedt acids may also catalyse the silane condensation. All acids which are compatible with the particular formulation can be employed. There are mentioned here by way of example p-toluenesulphonic acid, dodecylbenzenesulphonic acid or also citric acid.

Desiccants which may be mentioned are, in particular, alkoxysilyl compounds, such as vinyltrimethoxysilane, methyltrimethoxysilane, i-butyltrimethoxysilane, hexadecyltrimethoxy-silane.

Adhesion promoters which are employed are the known functional silanes, such as, for example, aminosilanes of the abovementioned type, but also N-aminoethyl-3-aminopropyltrimethoxy- and/or N-aminoethyl-3-aminopropylmethyldimethoxysilane, epoxysilanes and/or mercaptosilanes.

The following examples illustrate the present invention without limiting it.

### EXAMPLES

Unless stated otherwise, all the percentage data relate to per cent by weight (wt. %).

The ambient temperature of 23° C. prevailing at the time the experiments were carried out is called RT (room temperature).

The methods described below for the determination of the corresponding parameters were used for carrying out and evaluating the examples and are also the methods in general for determination of the parameters relevant according to the invention.

### Determination of the Isocyanate Content

The determination of the NCO contents in wt. % was carried out in accordance with DIN EN ISO 11909 by back-titration with 0.1 mol/l of hydrochloric acid after reaction with butylamine.

### Determination of the Viscosity

The viscosity measurements were carried out in accordance with ISO/DIN 3219:1990 at a constant temperature of 23° C. and a constant shear rate of 250/sec using a plate-cone rotary viscometer of the Physica MCR type (Anton Paar Germany GmbH, Ostfildern, DE) using the CP 25-1 measuring cone (25 mm diameter, 1° cone angle).

### Determination of the Molecular Weight

The molecular weight was determined with the aid of a GPC measurement, with polystyrene (PSS Polymer-Standard-Service GmbH, Mainz) as the standard. The apparatus used was a Hewlett Packard 1100 series II, which comprised the following columns:
1. Nucleogel GPC 10 P 50×7.8 mm; Macherey-Nagel
2. Nucleogel GPC 106-10 300×7.8 mm; Macherey-Nagel
3. Nucleogel GPC 104-10 300×7.8 mm; Macherey-Nagel
4. Nucleogel GPC 500-10 300×7.8 mm; Macherey-Nagel
5. Nucleogel GPC 100-10 300×7.8 mm; Macherey-Nagel

Tetrahydrofuran was used as the mobile phase, the flow rate was 0.6 ml/min, the pressure was 42 bar and the temperature was 30° C.

### Example 1 (According to the Invention)

In a 3 l sulfonating beaker with a lid, stirrer, thermometer and nitrogen flow, 2,070.3 g of polyether triol built up from propylene oxide and ethylene oxide (13 wt. %) and having a hydroxyl number of 56 mg of KOH/g and 0.07 g of dibutyltin dilaurate (Desmorapid® Z, Bayer MaterialScience AG) were heated to 60° C. 409.2 g of 3-isocyanatopropyltrimethoxysilane were then added at 60° C. and the mixture was stirred until the theoretical NCO content of 0.05% was reached. The excess NCO was taken up by addition of methanol. The polymer obtained, containing alkoxysilane end groups, had a viscosity of 1,900 mPas (23° C.) and a number-average molecular weight of 4,200 g/mol.

### Example 2 (According to the Invention)

In a 2 l sulfonating beaker with a lid, stirrer, thermometer and nitrogen flow, 813.4 g of poly(oxypropylene) tetrol started on ethylenediamine and having a hydroxyl number of 60 mg of KOH/g and 0.05 g of dibutyltin dilaurate (Desmorapid® Z, Bayer MaterialScience AG) were heated to 60° C. 186.6 g of 3-isocyanatopropyltrimethoxysilane were then added at 60° C. and the mixture was stirred until the theoretical NCO content of 0.05% was reached. The excess NCO was taken up by addition of methanol. The polymer obtained, containing alkoxysilane end groups, had a viscosity of 2,400 mPas (23° C.) and a number-average molecular weight of 4,200 g/mol.

### Example 3 (According to the Invention)

In a 2 l sulfonating beaker with a lid, stirrer, thermometer and nitrogen flow, 702.3 g of polypropylene glycol having a hydroxyl number of 112 mg of KOH/g and 0.05 g of dibutyltin dilaurate (Desmorapid® Z, Bayer MaterialScience AG) were heated to 60° C. 297.7 g of 3-isocyanatopropyltrimethoxysilane were then added at 60° C. and the mixture was stirred until the theoretical NCO content of 0.05% was reached. The excess NCO was taken up by addition of methanol. The polymer obtained, containing alkoxysilane end groups, had a viscosity of 760 mPas (23° C.) and a number-average molecular weight of 1,900 g/mol.

### Example 4 (According to the Invention)

In a 2 l sulfonating beaker with a lid, stirrer, thermometer and nitrogen flow, 339.0 g of polypropylene glycol having a hydroxyl number of 515 mg of KOH/g and 0.05 g of dibutyltin dilaurate (Desmorapid® Z, Bayer MaterialScience AG) were heated to 60° C. 661.0 g of 3-isocyanatopropyltrimethoxysilane were then added at 60° C. and the mixture was stirred until the theoretical NCO content of 0.05% was reached. The excess NCO was taken up by addition of methanol. The polymer obtained, containing alkoxysilane end groups, had a viscosity of 480 mPas (23° C.) and a number-average molecular weight of 710 g/mol.

### Example 5 (According to the Invention)

In a 2 l sulfonating beaker with a lid, stirrer, thermometer and nitrogen flow, 432.2 g of Jeffamine® SD-231 having an amine number of 356 mg of KOH/g were heated to 60° C. 570.3 g of 3-isocyanatopropyltrimethoxysilane were then added at 60° C. and the mixture was stirred until the theoretical NCO content of 0.05% was reached. The excess NCO was taken up by addition of methanol. The polymer obtained, containing alkoxysilane end groups, had a viscosity of 5,000 mPas (23° C.) and a number-average molecular weight of 650 g/mol.

### Example 6 (According to the Invention)

In a 2 l sulfonating beaker with a lid, stirrer, thermometer and nitrogen flow, 832.2 g of Jeffamine® D-2000 having an amine number of 56 mg of KOH/g were heated to 60° C. 170.3 g of 3-isocyanatopropyltrimethoxysilane were then added at 60° C. and the mixture was stirred until the theoretical NCO content of 0.05% was reached. The excess NCO was taken up by addition of methanol. The polymer obtained, containing alkoxysilane end groups, had a viscosity of 3,450 mPas (23° C.) and a number-average molecular weight of 3,100 g/mol.

### Comparative Example 1

In a 2 l sulfonating beaker with a lid, stirrer, thermometer and nitrogen flow, 882.2 g of polypropylene glycol having a hydroxyl number of 28 mg of KOH/g and 0.05 g of dibutyltin dilaurate (Desmorapid® Z, Bayer MaterialScience AG) were heated to 60° C. 115.9 g of 3-isocyanatopropyltrimethoxysilane were then added at 60° C. and the mixture was stirred until the theoretical NCO content of 0.05% was reached. The excess NCO was taken up by addition of methanol. The polymer obtained, containing alkoxysilane end groups, had a viscosity of 2,400 mPas (23° C.) and a number-average molecular weight of 4,900 g/mol.

### Comparative Example 2

In a 2 l sulfonating beaker with a lid, stirrer, thermometer and nitrogen flow, 902.2 g of poly(oxypropylene) triol having a hydroxyl number of 28 mg of KOH/g and 0.15 g of dibutyltin dilaurate (Desmorapid® Z, Bayer MaterialScience AG) were heated to 60° C. 97.8 g of 3-isocyanatopropyltrimethoxysilane were then added at 60° C. and the mixture was stirred until the theoretical NCO content of 0.05% was reached. The excess NCO was taken up by addition of methanol. The polymer obtained, containing alkoxysilane end groups, had a viscosity of 3,200 mPas (23° C.) and a number-average molecular weight of 5,000 g/mol.

### Use Examples

To evaluate the use properties of the various polymers, these were processed into the following adhesive formulation:

| | Amount employed in wt. % |
|---|---|
| Polymer | 46.06 |
| Filler (Socal ® U₁S₂) | 49.75 |
| Desiccant (Dynasylan ® VTMO) | 2.76 |
| Adhesion promoter (Dynasylan ® 1146) | 1.38 |
| Catalyst (Lupragen ® N700) | 0.05 |

For preparation of the formulation, the filler (Socal® U1S2; Solvay GmbH) and the desiccant (Dynasylan® VTMO; Evonik AG) are added to the polymer and the components are mixed in a vacuum dissolver with a wall scraper at 3,000 rpm. The adhesion promoter (Dynasylan® 1146; Evonik AG) is then added and is stirred into the mixture at 1,000 rpm in the course of 5 min. Finally, the catalyst (Lupragen® N700; BASF SE) is stirred in at 1,000 rpm and in conclusion the finished mixture is deaerated in vacuo.

### Determination of the Skin Formation Time

A film of the adhesive is applied by means of a doctor blade (200 μm) to a glass plate cleaned beforehand with ethyl acetate, and is immediately laid in the Drying Recorder. The needle is loaded with 10 g and moves over a distance of 35 cm over a period of 24 hours.

The Drying Recorder is in a climatically controlled room at 23° C. and 50% rel. atmospheric humidity.

The point in time of disappearance of the permanent trace of the needle from the film is stated as the skin formation time.

The skin formation time was determined 1 day after the preparation of the corresponding formulation.

Determination of the Tensile Shear Strength

For determination of the tensile shear strength, singly overlapped test specimens of beech having an overlapping length of 10 mm and an adhesive gap thickness of about 1 mm are used. The pieces of beech wood required for this have the following dimensions: length=40 mm, width=20 mm, thickness=5 mm. The test specimens are stored for 7 days at 23° C. and 50% rel. atmospheric humidity, thereafter 20 days at 40° C. and in conclusion one day at 23° C. and 50% rel. atmospheric humidity.

The tensile shear strength is measured on a tensile tester at speed of advance of 100 mm/min.

The following table shows the results obtained:

| | Comparative | | | | | | | |
|---|---|---|---|---|---|---|---|---|
| | Example no. | | Example no. | | | | | |
| | 1 | 2 | 1 | 2 | 3 | 4 | 5 | 6 |
| OH/NH number of the | 28 | 28 | 56 | 60 | 112 | 515 | 56 | 356 |
| polyether | | | | | | | | |
| [mg of KOH/g] | | | | | | | | |
| Skin formation time [min] | 60 | 45 | 30 | 25 | 255 | 75 | 215 | 270 |
| Tensile shear strength [N/mm²] | 3.1 | 4.2 | 6.3 | 7.8 | 6.1 | 8.4 | 6.4 | 10.1 |

1-11. (canceled)

12. A polymer modified with alkoxysilane groups, which are obtainable by reacting
a) compounds or mixtures of compounds having isocyanate-reactive groups and a hydroxyl number or amine or thiol number of greater than 30 mg of KOH/g+
with
b) an isocyanate-functional alkoxysilane compound of the general formula (I): 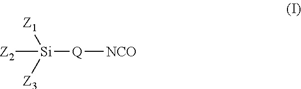
wherein
Z₁, Z₂ and Z₃ are identical or different C₁-C₈-alkoxy or C₁-C₈-alkyl radicals,
which can also be bridged, but wherein at least one C₁-C₈-alkoxy radical must be present on each Si atom,
Q is an at least difunctional linear or branched organic radical.

13. The polymer according to claim 12, wherein Q is an alkylene radical having 1 to 8 carbon atoms.

14. The polymer according to claim 12, wherein X, Y and Z in formula (I) independently of each other are a methoxy or ethoxy group and R is a methylene or propylene radical.

15. The polymer according to claim 12, wherein polyhydroxy compounds are employed as compounds having isocyanate-reactive groups.

16. The polymer according to claim 12, wherein polyether polyols are employed as compounds having isocyanate-reactive groups.

17. The polymer according to claim 12, wherein they have a viscosity at 23° C. of less than 20 Pas.

18. The polymer according to claim 12, wherein they have a viscosity at 23° C. of less than 10 Pas.

19. The polymer according to claim 12, wherein they have a viscosity at 23° C. of less than 5 Pas.

20. The polymer according to claim 13, wherein X, Y and Z in formula (I) independently of each other are a methoxy or ethoxy group and R is a methylene or propylene radical and polyhydroxy compounds are employed as compounds having isocyanate-reactive groups and polyether polyols are employed as compounds having isocyanate-reactive groups and wherein they have a viscosity at 23° C. of less than 5 Pas.

21. An adhesive, coating or foam which comprises the polymer according to claim 12.

22. An adhesive and coating preparation comprising
5 wt. % to 100 wt. % of a polymer modified with alkoxysilane groups, according to claim 12, or of a mixture of two or more polymers modified with alkoxysilane groups,
0 wt. % to 30 wt. % of a plasticizer or of a mixture of two or more plasticizers,
0 wt. % to 30 wt. % of a solvent or of a mixture of two or more solvents,
0 wt. % to 5 wt. % of a moisture stabilizer or of a mixture of two or more moisture stabilizers,
0 wt. % to 5 wt. % of an antiageing agent or of a mixture of two or more antiageing agents,
0 wt. % to 5 wt. % of a catalyst or of a mixture of two or more catalysts and
0 wt. % to 80 wt. % of a filler or of a mixture of two or more fillers.

23. The adhesive according to claim 22, wherein 5 wt. % to 100 wt. % of a polymer modified with alkoxysilane groups, according to claim 12, or of a mixture of 5 polymers modified with alkoxysilane groups.

24. The adhesive according to claim 22, having a tensile shear strength of greater than 5 N/mm².

25. A substrate bonded using the adhesive according to claim 22.
